(19) United States
(12) Patent Application Publication
(10) Pub. No.: US 2014/0167972 A1
(43) Pub. Date: Jun. 19, 2014

(54) ACOUSTICALLY-RESPONSIVE OPTICAL DATA ACQUISITION SYSTEM FOR SENSOR DATA

(71) Applicant: GENERAL ELECTRIC COMPANY, Schenectady, NY (US)

(72) Inventors: Glen Peter Koste, Niskayuna, NY (US); Judith Ann Guzzo, Niskayuna, NY (US); Thomas Allen Fraser, Houston, TX (US)

(73) Assignee: GENERAL ELECTRIC COMPANY, Schenectady, NY (US)

(21) Appl. No.: 13/713,116

(22) Filed: Dec. 13, 2012

(51) Int. Cl. G01V 3/30

(52) U.S. Cl. CPC G01V 3/30
USPC 340/854.7

(57) ABSTRACT

A sensing and data acquisition system may provide a sensing assembly including a signal conditioner to receive an electrical signal from a sensor affixed onto an asset and supply an encoded digital representation of a sensed parameter. An acoustic modem may be connected to the signal conditioner to receive the encoded digital representation of the sensed parameter and transmit an acoustic signal based on the encoded digital representation of the sensed parameter. A data acquisition line may be proximate to the asset and may be non-contactively coupled to the sensing assembly. The data acquisition line may include an optical fiber acoustically coupled to the acoustic modem and responsive to the encoded digital representation of the sensed parameter transmitted by the modem to effect an optical change in an acoustically-responsive portion of the fiber. The optical change may be measurable to detect the encoded digital representation of the sensed asset parameter.

### FIELD OF THE INVENTION

The present invention is generally directed to sensing and data acquisition, and, more particularly, to a sensing and data acquisition system, as may involve an acoustically-responsive optical data acquisition line non-contactively coupled to a sensing system.

### BACKGROUND OF THE INVENTION

Certain industries as may operate in extreme environments, such as may be involved in the extraction of natural resources from underground sites, may face a multitude of challenges to appropriately meet safety and environmental regulations while sustaining profitable returns. For example, industries involved in offshore drilling (e.g., to extract petroleum and natural gas) may operate in a relatively deep-water environment, and from time-to-time may have to deal with major weather-related events (e.g. hurricanes, storms), cyclical motion due to waves and ocean currents, and excessive bending and strain during deployment, operation, and recovery operations. Physical assets which may be used to perform subsea operations, (such as long, flexible cylindrical structures, e.g., risers, flowlines, tendons, mooring lines, etc.) may experience metal fatigue due to cyclical motion or other damage from singular events.

These vibrations, often occurring at high frequencies over extended periods of time, could eventually result in costly and burdensome catastrophic structural failure of a given asset due to fatigue damage accumulation. Accordingly, in spite of the challenges of such extreme operational environments, sensing and acquisition of asset parameters of interest is imperative to gain appropriate understanding of the physical integrity (e.g., accumulation of VIV) of a given asset, with an aim of accurately monitoring and estimating fatigue damage so as to proactively take appropriate measures before a catastrophic malfunction occurs. At least in view of the foregoing considerations, there is a need for improved sensing and data acquisition systems that permit reliable and cost-effective acquisition of data at least in such challenging environments.

### SUMMARY OF THE INVENTION

Generally, aspects of the present invention in one example embodiment may provide a sensing and data acquisition system including a sensing system affixed onto an asset to sense at least one asset parameter. The sensing system may provide at least one sensor assembly including at least one sensor to generate a respective electrical signal indicative of a sensed asset parameter. The sensing assembly may further provide a signal conditioner connected to receive the respective electrical signal from the sensor and supply an encoded digital representation of the sensed asset parameter. An acoustic modem may be connected to the signal conditioner to receive the encoded digital representation of the sensed asset parameter and transmit an acoustic signal based on the encoded digital representation of the sensed asset parameter. A data acquisition line may be disposed proximate to the asset and non-contactively coupled to the sensing system. The data acquisition line may include an optical fiber acoustically coupled to the acoustic modem and responsive to the encoded digital representation of the sensed asset parameter transmitted by the modem to effect an optical change in an acoustically-responsive portion of the fiber. The optical change may be measurable to detect the encoded digital representation of the sensed asset parameter.

Further aspects of the present invention in another example embodiment may provide a sensing and data acquisition system including a sensing assembly, which in turn may include a signal conditioner connected to receive a respective electrical signal from at least one sensor affixed onto an asset and supply an encoded digital representation of at least one sensed asset parameter. An acoustic modem may be connected to the signal conditioner to receive the encoded digital representation of the sensed asset parameter and transmit an acoustic signal based on the encoded digital representation of the sensed asset parameter. A data acquisition line may be disposed proximate to the asset and may be non-contactively coupled to the sensing assembly. The data acquisition line may include an optical fiber acoustically coupled to the acoustic modem and responsive to the encoded digital representation of the sensed asset parameter transmitted by the modem to effect an optical change in an acoustically-responsive portion of the fiber. The optical change may be measurable to detect the encoded digital representation of the sensed asset parameter.

### BRIEF DESCRIPTION OF THE DRAWINGS

The invention is explained in the following description in view of the drawings that show:

FIG. 1 is a schematic representation of a sensing and data acquisition system embodying aspects of the present invention, as may be used in one example application.

FIG. 2 provides a zoomed-in view of a portion of the schematic shown in FIG. 1.

FIG. 3 is a block diagram of an example sensor assembly embodying aspects of the present invention.

FIG. 4 in part shows a block diagram representation of one example embodiment of an optical interrogator, which may be used as part of a sensing and data acquisition system embodying aspects of the present invention.

FIG. 5 in part shows a block diagram representation of another example embodiment of an optical interrogator, which may be used as part of a sensing and data acquisition system embodying aspects of the present invention.

FIGS. 6 and 7 illustrate respective schematics of example acoustically-responsive optical fiber portions, as may be geometrically arranged to improve acoustic coupling in an under-water environment.

FIG. 8 is a schematic representation of a data acquisition line embodying aspects of the present invention, and which line may function as an umbilical data acquisition line to acquire data from separate sensing systems respectively affixed onto two or more spaced-apart assets.

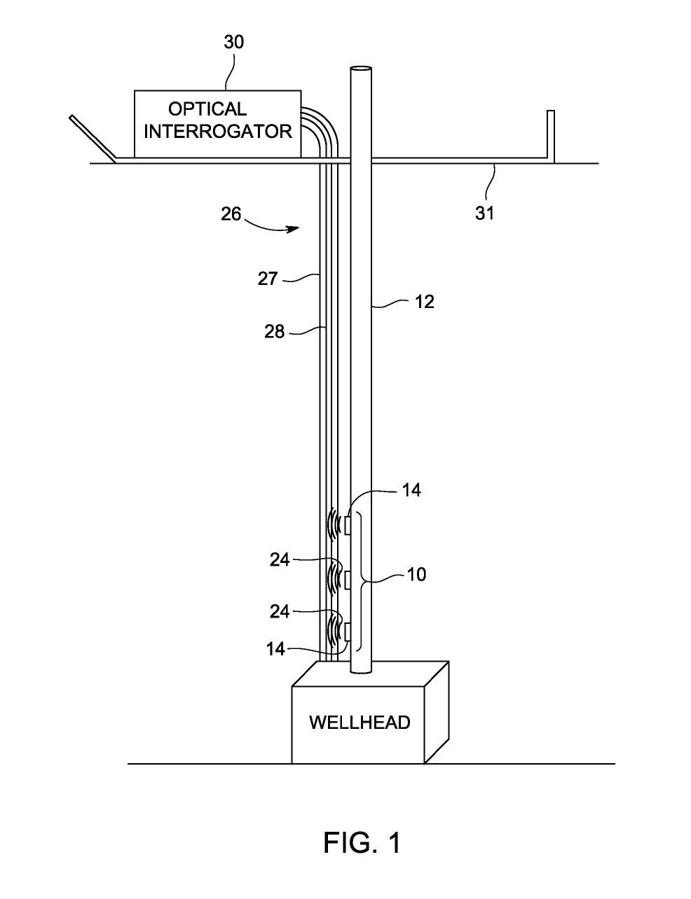

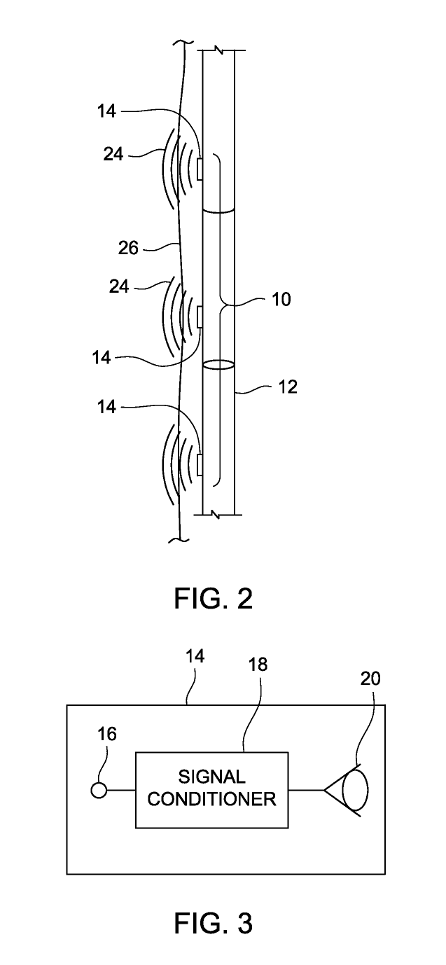

### DETAILED DESCRIPTION OF THE INVENTION

In the following detailed description, numerous specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, to avoid pedantic and unnecessary description well known methods, procedures, and components have not been described in detail.

Furthermore, various operations may be described as multiple discrete steps performed in a manner that is helpful for understanding embodiments of the present invention. However, the order of description should not be construed as to imply that these operations need be performed in the order they are presented, nor that they are even order dependent. Moreover, repeated usage of the phrase “in one embodiment” does not necessarily refer to the same embodiment, although it may. Lastly, the terms “comprising”, “including”, “having”, and the like, as used in the present application, are intended to be synonymous unless otherwise indicated.

In one example embodiment, a sensing and data acquisition system embodying aspects of the present invention may include a sensing system 10 affixed onto an asset 12 to sense at least one asset parameter. In one example embodiment, asset 12 may be a subsea riser and example asset parameters which may be monitored by sensing system 10 may be strain, temperature, pressure, position, velocity, and acceleration.

It will be appreciated that aspects of the present invention are not limited to applications involving subsea assets since other types of assets may equally benefit from a sensing and data acquisition system embodying aspects of the present invention, such as subsurface assets (e.g., assets involved in mining operations), aboveground assets, combinations of at least some of the foregoing assets, etc. Sensing system 10 may include one or more sensor assemblies 14, which may include one or more sensors 16 (FIG. 3), which may generate a respective electrical signal indicative of a sensed asset parameter. In one example embodiment, sensor assemblies 14 may be clamped or otherwise affixed at various points of the asset, such as along a length of the asset.

In one example embodiment, sensor assembly 14 may include a signal conditioner 18, as, for example, may include amplification circuitry, analog-to-digital converter circuitry, and encoding circuitry, connected to receive the respective electrical signal from sensor 16 and supply an encoded digital representation of the sensed asset parameter. Sensing system 10 may further include an acoustic modem 20 connected to signal conditioner 18 to receive the encoded digital representation of the sensed asset parameter and transmit an acoustic signal (e.g,, schematically represented by wavefronts 24) based on the encoded digital representation of the sensed asset parameter. In one example embodiment, the encoded digital representation may include a parity bit, as may be arranged to detect transmission errors in the transmitted acoustic signal in a presence of acoustic noise. In one example embodiment, sensor 16 could be a component separate from sensor assembly 14. For example, an add-on sensor assembly to a field-deployed sensor may just include the signal conditioner and acoustic modem.

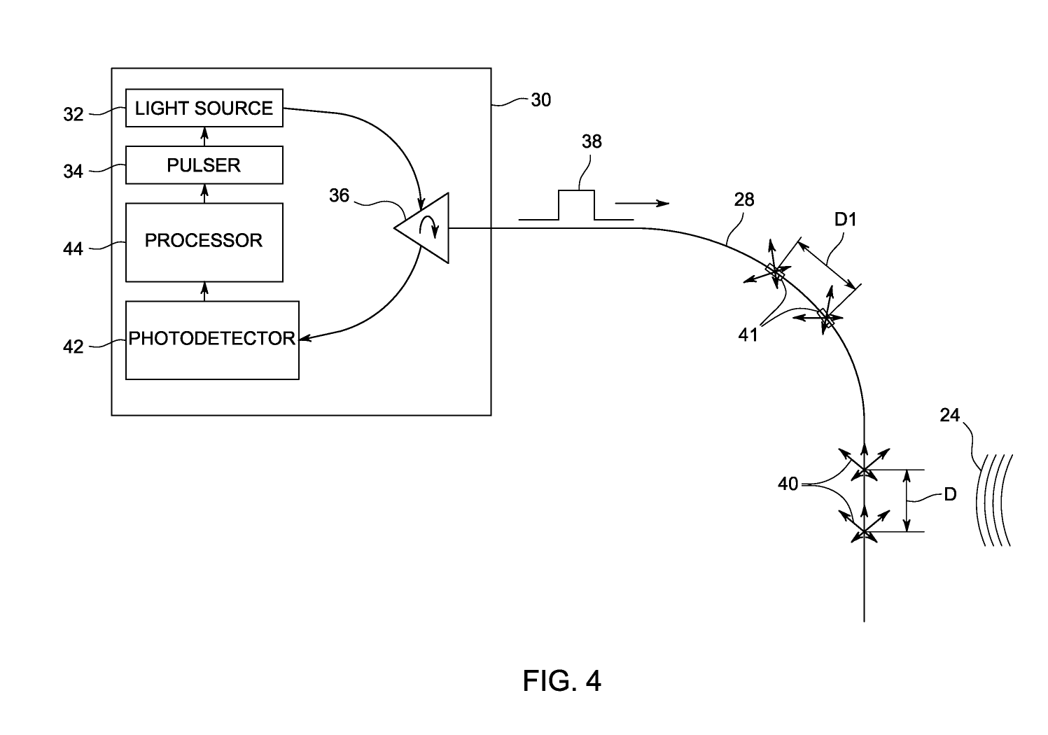

A data acquisition line 26 may be disposed proximate to asset 12 (e.g., in a range from approximately a few centimeters to approximately a few hundred meters or more) and may be non-contactively coupled to sensing system 10. For example, data acquisition line 26 may be made up of a protective jacket 27, which houses an optical fiber 28 acoustically coupled to acoustic modem 20 to be responsive to the encoded digital representation of the sensed asset parameter transmitted by the modem to effect an optical change in a respective portion of the fiber (e.g., acoustically-responsive fiber portion D in FIG. 4). The optical change is measurable to detect the encoded digital representation of the sensed asset parameter.

In one example embodiment, an optical interrogator 30, which in one example application may be disposed onboard a vessel 31, may include an optical source 32 (FIG. 4), such as a source of coherent light responsive to a pulser 34. Optical source 32 may be coupled through a circulator 36 to one end of the fiber to apply at least one optical pulse, (e.g., represented by pulse 38) which when the pulse passes through the respective acoustically-responsive fiber portion D conveys respective optical backscatter portions (e.g., schematically represented by arrows 40) for measurement of the optical change in the fiber portion to detect the encoded digital representation of the respective sensed parameter. In one example embodiment, the respective portion of the fiber (e.g., acoustically-responsive fiber portion D1) may extend between two fiber grating sites 41, such as may include respective fiber Bragg gratings (FBGs). In operation, data acquisition line 26 and optical interrogator 30 effectively form an acoustically-responsive telemetry system for sensor data (e.g., as may comprise one or more sensed asset parameters).

In one example embodiment, as shown in FIG. 4, a photodetector 42 (e.g., a photodiode) may be coupled to receive the optical backscatter portions. Photodetector 42 converts the received optical backscatter portions into an electrical signal which may be supplied to a processor 44 for suitable signal processing. For example, when a given acoustically-responsive portion of optical fiber 28 is excited by acoustic waves transmitted from a corresponding modem, the backscattered light is altered at a time, which may be relatable to the location of the excitation. For example, using signal processing techniques well-understood by those skilled in the art, (e.g., time division multiplexing) the electrical signal received by processor 44 may be processed in a temporal-resolved manner to determine the location of the acoustic excitation and in turn the location of the corresponding modem and sensor associated with such acoustic excitation. For example, the backscattered portions may be grouped into respective time intervals according to their respective time delays, where each time interval may correspond to a respective acoustically-responsive portion of fiber 28 (e.g., among a plurality of spaced-apart acoustically-responsive fiber portions) located at a particular distance from circulator 36 along optical fiber 28. In one example embodiment, respective phase changes in the backscattered portions in a given time interval would indicate the encoded digital representation of the respective sensed parameter being monitored at the location corresponding to that time interval.

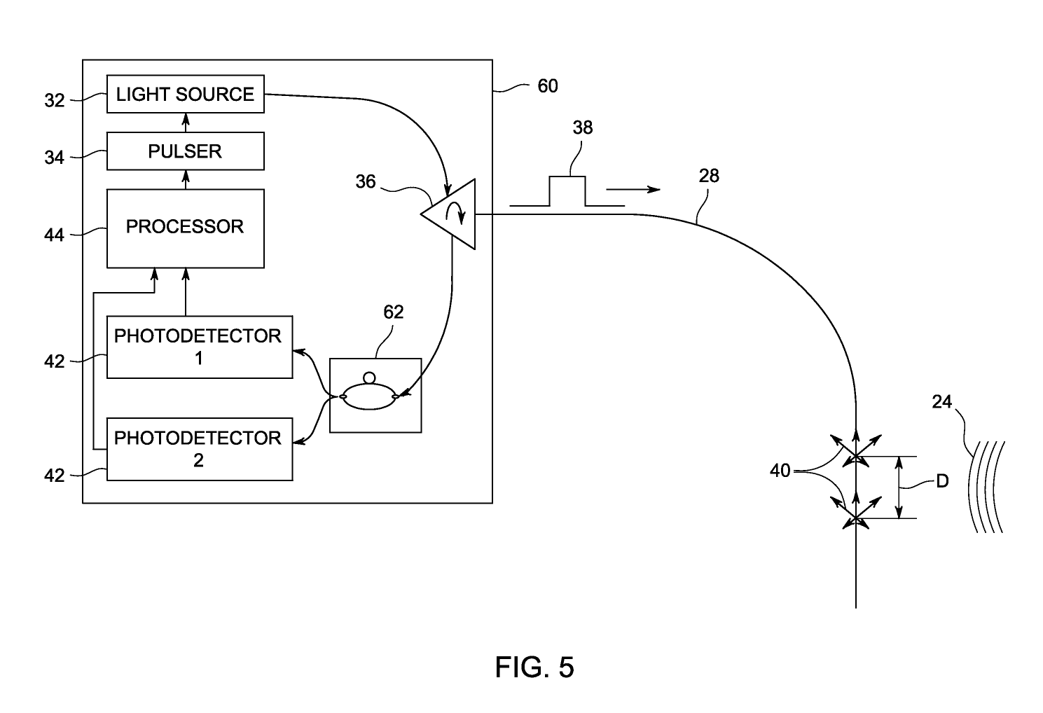

In one example embodiment, as shown in FIG. 5, an optical interrogator 60 may include a Mach-Zender interferometer (MZI) 62 arranged to introduce an optical path delay effective to cause the optical backscatter portions to coherently interfere on one or more photodetectors 42 optically coupled to receive the respective optical outputs conveyed through the output ports of MZI 62. For readers desirous of general background information in connection with optical time-domain reflectometer (OTDR) techniques, reference is made to technical paper titled “Interferometric Optical Time-Domain Reflectometry for Distributed Optical-Fiber Sensing,” by Sergey V. Shatalin, Vladimir N. Treschikov, and Alan J. Rogers, Appl. Opt. 37, 5600-5604 (1998) and U.S. Pat. No. 5,194,847, each of which is incorporated herein by reference.

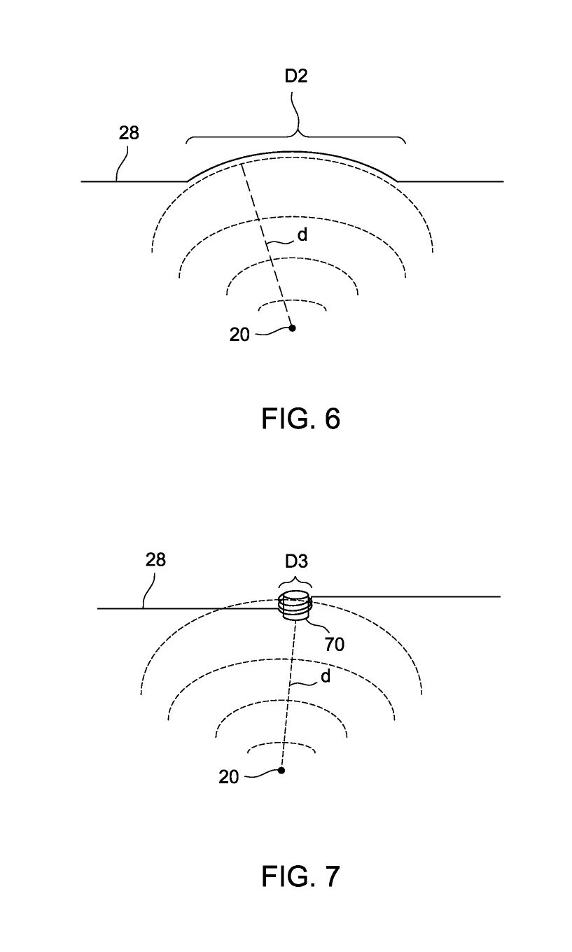

FIGS. 6 and 7 illustrate respective schematics of example acoustically-responsive fiber portions D2 and D3, which may be arranged to improve acoustic coupling, such as in an under-water environment, particularly at higher frequencies. For example, in some example applications higher frequencies may be desirable to achieve relatively higher data rates and/or relatively stronger immunity to noise. This may be achieved by arranging the acoustically-responsive portion of the optical fiber to be substantially equidistant from the acoustic signal source (e.g., acoustic modem 20). This may be achieved, as illustrated in FIG. 6, by forming an arc with the acoustically sensitive portion (e.g., fiber portion D2) of optical fiber 28 so that the fiber portion defined by the arc is substantially equidistant from acoustic modem 20. In another example embodiment, as illustrated in FIG. 7, this functionality may also be achieved by winding the acoustically-responsive portion (e.g., fiber portion D3) of optical fiber 28 in a spool 70, which practically concentrates the acoustically-sensitive portion of optical fiber 28 over a relatively small area and thus effectively provides a substantially equidistant distance relative to acoustic modem 20.

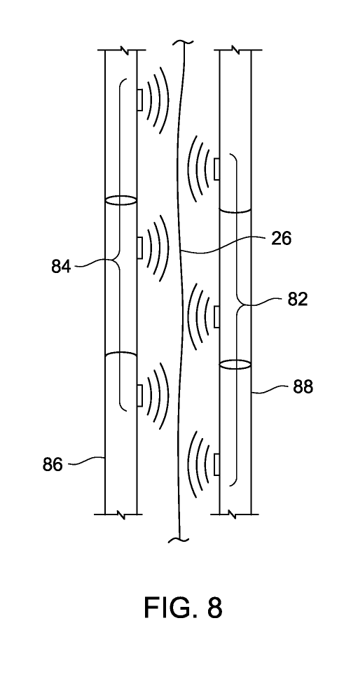

In one example embodiment, as illustrated in FIG. 8, data acquisition line 26 may function as an umbilical data acquisition line to acquire data from separate sensing systems 82 and 84, as may be respectively affixed onto spaced-apart assets, such as assets 86 and 88. In this example embodiment, by way of a single data acquisition line (e.g., umbilical data acquisition line 26) in a cost effective manner one can acquire data from spaced-apart assets 86 and 88. It will be appreciated that aspects of the present invention are not limited to any specific number of assets whose data may be acquired by a single data acquisition line. Depending on the needs of a given application, and the co-proximity of respective acoustic modems in sensing systems 82 and 84 to the respective acoustically-responsive portions of the data acquisition line, the encoded digital representations of the sensed asset parameter may optionally be further adapted to identify the source of the data—in this example, the encoding could be adapted to indicate whether the data is from asset 86, or from asset 88, in addition to detecting transmission errors in the transmitted acoustic signal.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A sensing and data acquisition system comprising:
a sensing system affixed onto an asset to sense at least one asset parameter;
the sensing system comprising at least one sensor assembly comprising at least one sensor to generate a respective electrical signal indicative of a sensed asset parameter;
the sensing assembly further comprising:
a signal conditioner connected to receive the respective electrical signal from said at least one sensor and supply an encoded digital representation of the sensed asset parameter;
an acoustic modem connected to the signal conditioner to receive the encoded digital representation of the sensed asset parameter and transmit an acoustic signal based on the encoded digital representation of the sensed asset parameter; and
a data acquisition line proximate to the asset and non-contactively coupled to the sensing system, the data acquisition line comprising an optical fiber acoustically coupled to the acoustic modem and responsive to the encoded digital representation of the sensed asset parameter transmitted by the modem to effect an optical change in an acoustically-responsive portion of the fiber, the optical change being measurable to detect the encoded digital representation of the sensed asset parameter.

2. The system of claim 1, further comprising an optical interrogator comprising an optical source coupled to one end of the fiber to apply at least one optical pulse, which when passing through the acoustically-responsive fiber portion conveys respective optical backscatter portions for measurement of the optical change in the fiber portion to detect the encoded digital representation of the respective sensed parameter.

3. The system of claim 1, wherein the respective sensed parameter comprises a parameter selected from the group consisting of strain, temperature, pressure, position, velocity, and acceleration.

4. The system of claim 2, wherein the optical source comprises a source of coherent light.

5. The system of claim 4, wherein the optical interrogator comprises a Mach-Zender interferometer arranged to introduce an optical path delay and cause coherent interference of the respective optical backscatter portions, and further comprises at least one photodetector optically coupled to receive respective coherently-interfered optical outputs from the interferometer.

6. The system of claim 1, wherein the respective portion of the fiber extends between two fiber grating sites.

7. The system of claim 1, wherein the asset comprises an asset selected from the group consisting of a subsea asset, a subsurface asset, an aboveground asset, and a combination of at least some of the foregoing assets.

8. The system of claim 1, wherein the asset comprises a subsea riser.

9. The system of claim 1, wherein the sensing system comprises a plurality of sensor assemblies to sense a plurality of asset parameters at various points at least along a length of the asset, wherein at least some of the plurality of sensor assemblies comprise respective signal conditioners and acoustic modems arranged to transmit respective acoustic signals based on respective encoded digital representations of the sensed asset parameters.

10. The system of claim 9, wherein the optical fiber is acoustically coupled to the respective acoustic modems and is responsive to the respective acoustic signals transmitted by the modems to effect respective optical changes in respective acoustically-responsive portions of the fiber, the optical changes being respectively measurable to detect the respective encoded digital representations of the sensed asset parameters.

11. The system of claim 10, further comprising an optical interrogator comprising an optical source coupled to one end of the fiber to apply at least one optical pulse, which when passing through the respective acoustically-responsive fiber portions conveys respective optical backscatter portions for measurement of the optical changes in the respective acoustically-responsive fiber portions to detect the respective encoded digital representations of the sensed asset parameters, wherein the optical interrogator comprises a processor arranged to temporally relate optical backscatter portions to a respective one of the portions of the fiber which is responsive to a respective one of the acoustic signals, and which in turn is based on a respective one of the encoded digital representations of an asset parameter sensed by one of the plurality of sensors.

12. The system of claim 1, wherein the respective portion of the optical fiber is geometrically arranged to be substantially equidistant from the acoustic modem.

13. The system of claim 1, wherein the encoded digital representation comprises a parity bit arranged to detect transmission errors in the transmitted acoustic signal in a presence of acoustic noise.

14. The system of claim 1, wherein the sensing system comprises respective sensing systems affixed onto respective assets spaced apart from one another, each sensing system comprising at least one sensor assembly comprising at least one sensor to generate a respective electrical signal indicative of a respective sensed asset parameter of the respective assets, wherein each sensing assembly comprise a signal conditioner and an acoustic modem arranged to transmit respective acoustic signals based on respective encoded digital representations of the sensed asset parameter of the respective assets.

15. The system of claim 14, wherein the data acquisition line comprises an umbilical data acquisition line to acquire data from the respective sensing systems affixed onto said space-apart assets, wherein the optical fiber is acoustically coupled to the respective acoustic modems and is responsive to the respective acoustic signals transmitted by the modems to effect respective optical changes in respective acoustically-responsive portions of the fiber, the respective optical changes being measurable to detect the encoded digital representations of the respective sensed asset parameter of the respective spaced-apart assets.

16. The system of claim 10, further comprising an optical interrogator comprising an optical source coupled to one end of the fiber to apply at least one optical pulse, which when passing through the respective acoustically-responsive fiber portions conveys respective optical backscatter portions for measurement of the optical changes in the respective acoustically-responsive fiber portions to detect the respective encoded digital representations of the respective sensed asset parameter from the respective spaced-apart assets, wherein the optical interrogator comprises a processor arranged to temporally relate optical backscatter portions to a respective one of the portions of the fiber which is responsive to a respective one of the acoustic signals, and which in turn is based on the encoded digital representation of the respective asset parameter from one of the respective spaced-apart assets.

17. A sensing and data acquisition system comprising:
a sensing assembly comprising:
a signal conditioner connected to receive a respective electrical signal from at least one sensor affixed onto an asset and supply an encoded digital representation of at least one sensed asset parameter;
an acoustic modem connected to the signal conditioner to receive the encoded digital representation of the sensed asset parameter and transmit an acoustic signal based on the encoded digital representation of the sensed asset parameter; and
a data acquisition line proximate to the asset and non-contactively coupled to the sensing assembly, the data acquisition line comprising an optical fiber acoustically coupled to the acoustic modem and responsive to the encoded digital representation of the sensed asset parameter transmitted by the modem to effect an optical change in an acoustically-responsive portion of the fiber, the optical change being measurable to detect the encoded digital representation of the sensed asset parameter.

18. The system of claim 17, wherein the sensor assembly comprises said at least one sensor affixed onto the asset.

19. The system of claim 17, further comprising an optical interrogator comprising an optical source coupled to one end of the fiber to apply at least one optical pulse, which when passing through the acoustically-responsive fiber portion conveys respective optical backscatter portions for measurement of the optical change in the fiber portion to detect the encoded digital representation of the respective sensed parameter.

20. The system of claim 17, wherein the respective sensed parameter comprises a parameter selected from the group consisting of strain, temperature, pressure, position, velocity, and acceleration.

21. The system of claim 19, wherein the optical source comprises a source of coherent light.

22. The system of claim 21, wherein the optical interrogator comprises a Mach-Zender interferometer arranged to introduce an optical path delay and cause coherent interference of the respective optical backscatter portions, and further comprises a photodetector pair optically coupled to receive respective coherently-interfered optical outputs from the interferometer.

23. The system of claim 17, wherein the respective portion of the fiber extends between two fiber grating sites.

24. The system of claim 17, wherein the asset comprises an asset selected from the group consisting of a subsea asset, a subsurface asset, an aboveground asset, and a combination of at least some of the foregoing assets.

25. The system of claim 17, wherein the asset comprises a subsea riser.

26. A telemetry system comprising the sensing and data acquisition system of claim 17.
